(19) United States
(12) Patent Application Publication
(10) Pub. No.: US 2014/0260775 A1
(43) Pub. Date: Sep. 18, 2014

(54) ENCODER SELECTOR FOR A MODULE OF A HOUSEHOLD COOKING APPLIANCE

(71) Applicant: BSH HOME APPLIANCES CORPORATION, Irvine, CA (US)

(72) Inventors: John Freeman, Knoxville, TN (US); Samuel Harward, Knoxville, TN (US); Jeremiah Nash, Knox, TN (US)

(73) Assignee: BSH HOME APPLIANCES CORPORATION, Irvine, CA (US)

(21) Appl. No.: 13/832,213

(22) Filed: Mar. 15, 2013

(51) Int. Cl. G05G 1/10

(52) U.S. Cl. CPC G05G 1/10
USPC 74/553

(57) ABSTRACT

A household cooking appliance is provided in which the household cooking appliance includes a cooking module, a control panel, a rotatable control knob, and a dual-encoder ON/OFF selector for the cooking module. The dual-encoder ON/OFF selector includes a rotatable bezel on the control panel. The rotatable bezel controls activation and deactivation of the cooking module. The rotatable bezel includes an opening, wherein the rotatable control knob extends through the opening of the rotatable bezel and is concentrically arranged within the rotatable bezel.

### FIELD OF THE INVENTION

The present invention is directed to an encoder selector for a module of a household appliance, and more particularly, to a dual-encoder ON/OFF selector for a module of a household cooking appliance.

### BACKGROUND OF THE INVENTION

Household cooking appliances are increasingly becoming multi-modal in that these appliances typically now incorporate multiple different types of cooking functions. For example, a household cooking appliance may include one or more of a steam oven, a warming drawer, a convection oven, gas burners, a griddle, a grill, a teppanyaki grill, an induction heating element, a surface steamer bay, a wok burner, a deep fryer (e.g., deep fat fryer), or the like. All of these different cooking modalities are often provided by the same household cooking appliance. As the varieties of types of cooking proliferates, the user interfaces for the household appliance to control each of these different cooking modes may increase in complexity.

### SUMMARY OF THE INVENTION

The present invention, as illustrated for example in the exemplary embodiments, provides a dual-encoder ON/OFF selector for a cooking module of a household appliance, the dual-encoder ON/OFF selector including a rotatable bezel controlling activation and deactivation of the cooking module, the rotatable bezel being rotatable between an ON position and an OFF position for the cooking module, wherein the rotatable bezel includes an opening configured to receive a rotatable control knob extending through the opening in either direction such that the rotatable control knob is concentrically arranged within the rotatable bezel.

The present invention also provides a household cooking appliance including a cooking module, a control panel, a rotatable control knob on the control panel, and a dual-encoder ON/OFF selector for the cooking module on the control panel, the dual-encoder ON/OFF selector including a rotatable bezel controlling activation and deactivation of the cooking module, the rotatable bezel being rotatable between an ON position and an OFF position for the cooking module, wherein the rotatable bezel includes an opening, and wherein the rotatable control knob extends through the opening of the rotatable bezel and is concentrically arranged within the opening of the rotatable bezel.

In this way, the present invention provides a user interface that simplifies the controls of different cooking modalities while also providing a clean and uniform “knob-controlled” appearance for a household cooking appliance, which commonly is desirable to many high end household cooking appliance buyers because it provides a “classic” look in a high capability household appliance. The present invention also enables a variety of components or modules from various sources or manufacturers to be used to form various cooking modules, such as surface cooking modules or the like, for household cooking appliances, such as cooking ranges. The present invention provides a uniform user interface for each of the various modules and input types to activate/deactivate the module such that all of the controls have a similar appearance and/or function. In this way, all of the controls appear to a user to be from the same product or manufacturer even in cases in which the components of the appliance are from various sources or manufacturers. The present invention also can provide for activation/deactivation of each module in a simple, non-confusing manner with a minimal amount of hand movement as possible.

Prior to describing the exemplary embodiments in greater detail, and to provide a better understanding of the invention, this disclosure will first describe some of the problems with conventional controls of a household cooking appliance.

As explained above, household cooking appliances are increasingly becoming multi-modal and may include one or more of a steam oven, a warming drawer, a convection oven, gas burners, a griddle, a grill, a teppanyaki grill, an induction heating element, a surface steamer bay, a wok burner, a deep fryer (e.g., deep fat fryer), or the like. Each of a variety of different modules for different cooking modalities commonly may have completely different types and arrangements of control knobs, input devices, control devices, etc. For example, some modules may have a control design which includes a control box mounted behind a wall of the cabinet or control panel along with a knob having a stem (e.g., an integral stem, an integral wide plastic stem, a thin plastic stem, etc.) that passes through the wall of the cabinet or control panel and operates the control box. Another module (such as an electric cooktop) may include infinite switches having a stem (e.g., a thin stem, a thin plastic stem, a thin, integral plastic stem, etc.) that extends forward from the control box through the wall of the cabinet or control panel such that a knob can be mounted on the stem. In yet another module, a gas valve may include a stem (e.g., a thin stem, thin metal stem, etc.), which extends forward from behind the wall of the cabinet or control panel and through the wall of the cabinet or control panel to the front panel such that a knob can be mounted on the stem. As a result, existing conventional controls do not provide a user interface which provides adequate control over each desired cooking function out of the multiple different types of cooking functions while still being able to maintain a desired clean, uniform, ornamental appearance.

Not only do all of these different cooking modalities increase the complexity of the controls and prevent a uniform appearance to the user, but these different cooking modalities also increase power demand on the cooking appliance, depending on which modalities or how many modalities of the appliance are being operated at the same time. As a result, a user may operate multiple modalities at the same time and exceed, for example, a desired or maximum amp limit for that particular appliance.

To solve the foregoing problems, a dual-encoder ON/OFF selector for a cooking module of a household appliance has been provided in which the dual-encoder ON/OFF selector includes a rotatable bezel controlling activation and deactivation of the cooking module, the rotatable bezel being rotatable between an ON position and an OFF position for the cooking module, wherein the rotatable bezel includes an opening configured to receive a rotatable control knob extending through the opening in either direction such that the rotatable control knob is concentrically arranged within the rotatable bezel. A household cooking appliance also has been provided in which the household cooking appliance includes a cooking module, a control panel, a rotatable control knob on the control panel, and a dual-encoder ON/OFF selector for the cooking module on the control panel, the dual-encoder ON/OFF selector including a rotatable bezel controlling activation and deactivation of the cooking module, the rotatable bezel being rotatable between an ON position and an OFF position for the cooking module, wherein the rotatable bezel includes an opening, and wherein the rotatable control knob extends through the opening of the rotatable bezel and is concentrically arranged within the opening of the rotatable bezel.

More particularly, the dual-encoder ON/OFF selector and household cooking appliance according to the exemplary embodiments of the invention include an outer bezel that is rotatable to actuate an on-off switch (such as a micro-switch inside the bezel or behind the wall of the cabinet or control panel, or similar device). The rotatable outer bezel includes a “cutout” or opening that permits a stem of various different types of input knobs to pass through from either, or both, of the front side or the rear side of the bezel such that nearly any style of valve stem can pass through the middle. The knob is extended through the opening in the rotatable outer bezel and nested in the outer bezel to provide a ‘knob-in-knob’ arrangement. This bezel can be designed to reach up around the sides of the knob. The knob and rotatable outer bezel are concentrically arranged such that the bezel rotates about the knob around a common axis. In this way, a universal rotatable outer bezel can be mounted to the control panel and surround a knob independent of the type of knob.

A variety of knobs having a universal outward appearance can be provided with a variety of different arrangements of stems for interfacing with various types of input devices, control devices, etc. A knob having a universal appearance to the other knobs can be matched with or selected to have a corresponding stem interface arrangement to the particular input device or control device of the module. The selected knob then can be inserted through the opening of the universal outer bezel to engage the particular input device or control device while being nested in the outer bezel to provide a uniform appearance while controlling the particular module.

For example, a universal outer bezel is provided that permits a knob, which includes a direct mechanical connection to a gas valve that controls a gas burner, to pass through the cutout, for example, from a rear side of the knob-bezel. In another example embodiment, the knob-bezel can accommodate a knob shaft to pass through the cutout, for example from a front side of the knob-bezel, to an encoder, which may be disposed behind the bezel (e.g., inside the face plate of the appliance), to control the temperature of an oven. In another module (such as an electric cooktop), the input may include infinite switches having a stem or shaft (e.g., a thin, integral plastic stem or shaft, etc.) that extends forward from the control box through the wall of the cabinet or control panel such that a knob can be mounted on the stem or shaft. In yet another module, the input may include a switch having a shaft (e.g., a plastic blade-like shaft) upon which the knob can be mounted. In a further module, the input may include a traditional gas valve having a stem (e.g., a thin stem, thin metal stem, etc.), which extends forward from behind the wall of the cabinet or control panel and through the wall of the cabinet or control panel to the front panel such that a knob can be mounted on the stem. In still another module, the input may include a shaft of a thermostat with a bulb. In this way, each cooking module can have a different knob designed to fit over the specific stem of that cooking module and into the opening or cutout of the universal outer bezel, while providing a consistent and universal outward appearance of each knob of the appliance.

In an exemplary embodiment, the rotatable outer bezel controls an ON/OFF actuation of a first cooking module while the knob controls a setting, such as a temperature setting, of the first cooking module. In this way, the present invention can provide for activation/deactivation of each module in a simple, non-confusing manner with a minimal amount of hand movement as possible. For example, a user can turn the module on using the rotatable outer bezel while setting the temperature of the module with a single hand motion. In another embodiment, the rotatable outer bezel controls an ON/OFF actuation of a first cooking module while the knob controls a function or setting of a second, different cooking module.

In an exemplary embodiment, the present invention can include a rotatable outer bezel around each control knob having a switch or integral switch. In another embodiment, a microswitch can be mounted to the outside diameter of the rotatable outer bezel (i.e., encoder) on the back side of the control panel to increase available space for knob stems. The present invention provides a universal way of turning various modules on and off, while making their knobs all look uniform and interact in the same way. In an exemplary embodiment, the ON/OFF functionality provided by the outer bezel can be used as additional safety layer to prevent unintentional activation of a module. In other embodiments, the ON/OFF functionality provided by the outer bezel serves to let a main control board or controller know when a module is active or inactive such that the controller can enact appropriate power management strategies, which will be explained in greater detail below.

As explained above, the features of the present invention are important for providing a user interface that simplifies the controls of different cooking modalities while also providing a clean and uniform “knob-controlled” appearance for a household cooking appliance, which commonly is desirable to many high end household cooking appliance buyers because it provides a “classic” look in a high capability household appliance. The present invention also enables a variety of components or modules from various sources or manufacturers to be used to form various cooking modules, such as surface cooking modules or the like, for household cooking appliances, such as cooking ranges. The present invention provides a uniform user interface for each of the various modules and input types to activate/deactivate the module such that all of the controls have a similar appearance and/or function. In this way, all of the controls appear to a user to be from the same product or manufacturer even in cases in which the components of the appliance are from various sources or manufacturers. The present invention also can provide for activation/deactivation of each module in a simple, non-confusing manner with a minimal amount of hand movement as possible.

As explained above, the present invention recognizes that, not only do all of these different cooking modalities increase the complexity of the controls, but these different cooking modalities also increase power demand on the cooking appliance, depending on which modalities or how many modalities of the appliance are being operated at the same time. As a result, a user may operate multiple modalities at the same time and exceed, for example, a desired or maximum amp limit for that particular appliance. For example, some household cooking appliances may have a maximum amperage limit such as 50 amps, 30 amps, etc.

The bezel of the present invention can be used to turn ON/OFF various modules and/or components of the household cooking appliance to maintain the total amperage drawn by the appliance under the maximum amperage limit. This may be particularly beneficial when the appliance includes a module, for example that is manufactured by another manufacturer such as an off-the-shelf pre-wired module, that is not configured to, or cannot, interface with a control board of the appliance.

In an embodiment, the bezel can be configured to communicate with the control panel of the appliance. The bezel can be used to turn ON/OFF the module or component. The ON/OFF functionality provided by the outer bezel serves to let a main control board or controller know when a module is active or inactive such that the controller can enact appropriate power management strategies.

If the overall amperage drawn by the appliance when a first component or module is turned on exceeds the maximum allowable amps of the appliance, then the control panel can provide one or more of an error signal, error message, or the like to notify the user of the appliance that use of the first component or module will exceed the maximum allowable amps of the appliance and/or that one or more second components or modules must be turned off to reduce the total amps drawn by the appliance and free up allowable amperage for the first component or module to be operated.

In an embodiment, the control panel can provide an interface for a user regarding which components or modules are turned ON/OFF and maintain the total amperage drawn by the appliance at or below the maximum amps for the particular model or type of appliance.

For example, in operation, a user turns on a first component or module controlled by the bezel. The control panel determines if the amount of amps drawn by the first component or module will cause the total amps drawn by the appliance to exceed the maximum allowable amperage of the appliance. If the maximum allowable amperage of the appliance will not be exceeded, then the control panel turns on a relay to supply power to the first component or module. If the maximum allowable amperage of the appliance will be exceeded, then the control panel does not turn on the relay and instead provides one or more of an error signal, error notification, error message, or the like to inform the user that the first component or module will exceed the maximum allowable amps of the appliance and/or that one or more second components or modules must be turned off to reduce the total amps drawn by the appliance and free up allowable amperage for the first component or module to be operated.

In another exemplary embodiment, the ON/OFF functionality provided by the outer bezel can be used as an additional safety layer to prevent unintentional activation of a module. For example, if a particular module requires the outer bezel to be turned to the ‘on’ position to operate, an accidental or unintentional bumping or turning of the control knob for the module will not activate the module, thereby providing an additional safety layer on top of existing safety features of control knobs. In another example, the ON/OFF functionality provided by the outer bezel can be configured to provide a child safety layer, or an additional child safety layer, to deter or prevent activation of a module by a child.

For purposes of this disclosure, a cooking module can include one or more of a gas burner, a steam oven, a warming drawer, a convection oven, gas burners, a griddle, a grill, an induction heating element, a teppanyaki grill, a surface steamer bay, a wok burner, a deep fryer (e.g., deep fat fryer), or the like. The invention is not limited to any particular type of cooking module and other cooking modules, types of cooking modules, arrangements of cooking modules, and combinations of cooking modules are contemplated by the present invention.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 is a front view of a household cooking appliance according to an exemplary embodiment of the invention.

FIG. 2 is a perspective view of an assembly of a universal dual-encoder module ON/OFF selector and control knob according to an exemplary embodiment of the invention.

FIG. 3 is a side view of an assembly of a universal dual-encoder module ON/OFF selector and control knob according to an exemplary embodiment of the invention.

FIG. 4 is a side view of an assembly of a universal dual-encoder module ON/OFF selector and control knob according to another exemplary embodiment of the invention.

FIGS. 5A and 5B are perspective views of a dual-encoder module ON/OFF selector according to exemplary embodiments of the invention.

FIG. 6 is a schematic illustration of a dual-encoder module ON/OFF selector according to an exemplary embodiment of the invention.

FIG. 7 is a partial assembled side view of an assembly of a dual-encoder module ON/OFF selector and control knob on a control panel of a household appliance, according to an exemplary embodiment of the invention.

FIG. 8 is a partial assembled side view of an assembly of a dual-encoder module ON/OFF selector and control knob on a control panel of a household appliance, according to another exemplary embodiment of the invention.

FIG. 9 is a partial assembled side view of an assembly of a dual-encoder module ON/OFF selector and control knob on a control panel of a household appliance, according to another exemplary embodiment of the invention.

FIG. 10 is a schematic illustration of a module control system having a dual-encoder module ON/OFF selector according to an exemplary embodiment of the invention.

FIG. 11 is a schematic illustration of a module control system having a plurality of dual-encoder module ON/OFF selectors according to another exemplary embodiment of the invention.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Referring now to the drawings, FIGS. 1-11 illustrate exemplary embodiments of a dual-encoder module ON/OFF selector and a household cooking appliance having a dual-encoder module ON/OFF selector.

FIG. 1 illustrates an example of a household cooking appliance 100. Other household cooking appliances are contemplated within the spirit and scope of the invention. In the example appliance of FIG. 1, the household cooking appliance 100 includes one or more of an oven 102 (e.g., baking oven or convection oven), a steam oven 104, and a warming drawer 106. However, other arrangements and features are possible, such as a single oven range, a cooktop, among other arrangements. The appliance can be a stand-alone appliance, a built-in appliance, or an in-counter appliance.

The household cooking appliance 100 can include one or more gas burners 108 or induction heating elements (not shown). The household cooking appliance 100 can include one or more cooktop cooking modules 110, such as one or more of a griddle, a grill, an induction heating element, a teppanyaki grill, a surface steamer bay, a wok burner, a deep fryer (e.g., deep fat fryer), or the like. The exemplary embodiment of FIG. 1 shows a single module 110. However, other embodiments can include one or more modules 110 arranged in the appliance. The household cooking appliance 100 can include a control panel 112 having one or more control devices 114, such as control knobs, for controlling one or more components or modules of the appliance.

As shown in FIGS. 2 and 3, an exemplary embodiment of the present invention provides a control device 114 having a dual-encoder module ON/OFF selector including a universal rotatable bezel 116 for turning a cooking module 110 on and off. The bezel 116 is shown coupled to a control panel 112 of the household appliance 100. However, in other embodiments, the bezel 116 can be mounted on or coupled to a housing of the appliance 100 or another arrangement. As shown in FIG. 4, the bezel 116 can include base support 117 that is coupled to the control panel 112, housing, or the like of the household appliance 100 such that the bezel 116 is movable with respect to the base support 117 between an on position and an off position for the cooking module 110.

With reference again to FIGS. 2-4, a rotatable control knob 118 either abuts the rotatable bezel 116 or can be nested or partially nested within an opening formed in the bezel 116. In the example, the bezel 116 is concentrically arranged with the control knob 118 such that each rotates about a common axis A1.

As shown in FIG. 5A, the rotatable outer bezel can include a “cutout” or opening 120 that permits a stem of various different types of input knobs 118 to pass through from either, or both, of the front side or the rear side of the bezel 116. In this way, a knob 118 can be inserted or partially inserted through the opening 120 in the rotatable outer bezel 116 and nested in the outer bezel 116 to provide a ‘knob-in-knob’ arrangement, as shown for example in FIGS. 2 and 3. The opening 120 can extend all of the way through the bezel 116 as shown in FIG. 5A or partially through the bezel 116 as shown in FIG. 5B. In the exemplary embodiment of FIG. 5B, the bezel 116 includes a step or ledge 121 for receiving a corresponding step portion of the control knob 118. The exemplary features of a step or ledge 121 will be described in greater detail with reference to FIG. 9 below.

With reference to FIG. 6, an exemplary embodiment of the rotatable outer bezel 116 can be configured to actuate one or more on-off switches 124 (such as a micro-switch) for activating and/or deactivating a cooking module 110 of the appliance 100. In the illustrated example, the rotatable outer bezel 116 includes a rotatable ring 122a that is movable with respect to the fixed ring 122b such that a movement of the rotable ring 122a is configured to actuate an on-off switch 124. Alternatively, the ring 122a can be fixed and the ring 122b can rotate about the ring 122a. The on-off switch 124 (e.g., micro-switch) can be, for example, integral with the bezel 116, mounted inside a portion of the bezel 116, or behind a wall of the housing or control panel 112 of the appliance 100. For example, the microswitch can be mounted to the outside diameter of the encoder on the back side of the control panel 112 to increase available space for knob stems.

In an exemplary embodiment, the on-off switch 124 is an off-the-shelf, inexpensive snap action microswitch that detects rotation of the bezel 116 and communicates with a main control board (described with reference to FIGS. 10 and 11) to activate a relay (described with reference to FIGS. 10 and 11) for supplying power to a particular cooking module 110. In other embodiments, a specialty or custom designed on-off switch can be used.

With reference to FIGS. 7-9, various exemplary embodiments of a dual-encoder module ON/OFF selector including a universal rotatable bezel 116 and knob 118 will be described generally, followed by a detailed description of each exemplary arrangement of each of FIGS. 7-9. As explained above, each of a variety of different modules for different cooking modalities commonly may have completely different types and arrangements of control knobs, input devices, control devices, etc. As shown in FIGS. 7-9, a universal bezel 116 can be mounted to the control panel 112 (or housing, etc.) of the appliance 100 independent of whichever knob 118 is assembled with the bezel 116. In the illustrated examples, the bezel 116 includes a large inner diameter formed by an opening 120 such that nearly any style of control knob 118 and/or valve stem can pass through the middle of the bezel 116 from either the front (e.g., as shown in FIG. 7) or the rear (e.g., as shown in FIGS. 8 and 9). The control panel 112 (or housing, etc.) includes an opening 126 that permits a stem of a control device to pass through the control panel 112 in either direction to engage the knob 118. A size of the opening 126 can be configured to correspond to the particular type of control device and/or the size and shape of the stem of the control device. The control device can be mounted behind the control panel 112 (as shown in FIGS. 8 and 9), in front of the control panel 112 (not shown), or integrally formed with the control knob 118 (as shown in FIG. 7). As shown in FIGS. 7-9, the bezel 116 can be designed such that the control knob 118 is nested or partially nested within the walls of the bezel 116. In this way, the walls of the bezel 116 extend up around a portion of the sides of the knob 118 and the bezel 116 rotates concentric to the knob 118.

A variety of knobs 118 having a universal outward appearance can be provided with a variety of different arrangements of stems for interfacing with various types of input devices, control devices, etc. A knob 118 having a universal appearance to other knobs of the appliance 100 can be matched with or selected to have a corresponding stem interface arrangement to the particular input device or control device of the module 110. The selected knob 118 then can be inserted through the opening 120 of the outer bezel 122 to engage the particular input device or control device while being nested in the outer bezel 122 to provide a uniform appearance while controlling the particular module. In this way, each cooking module 110 of the appliance 100 can have a knob 118 and bezel 116 with a common external appearance and operation to the user, while each knob 118 can be differently configured to match and fit over the particular stem design of the particular control device of that module 110 such that differences in control types of the modules 110 or differences in the products or manufactures of the modules 110 are not perceivable by the user.

As explained above, each exemplary arrangement of FIGS. 7-9 will now be described.

With reference to the example illustrated in FIG. 7, a module 110 may have a control design which includes a control box 130 mounted behind a wall of the cabinet or control panel 112. A knob 118 can include a stem 128 (e.g., an integral plastic stem, integral wide plastic stem, etc.) that passes from the front through opening 120 of the bezel 116 and through the opening 126 of the wall of the cabinet or control panel 112 and operates the control box 130. In another embodiment, the control device can be integrally formed in the knob 118. As shown in FIG. 7, the bezel 116 can be designed such that the control knob 118 is nested or partially nested within the walls of the bezel 116. In this way, the walls of the bezel 116 extend up around a portion of the sides of the knob 118 and the bezel 116 rotates concentric to the knob 118.

With reference to the example illustrated in FIG. 8, another module 110 (such as an electric cooktop) may have a control design which includes a control box 132 mounted behind a wall of the cabinet or control panel 112. The control box 132 can include infinite switches having a stem 134 (e.g., a plastic stem, a thin integral plastic stem, a plastic blade-like shaft, etc.) that extends forward from the control box 132 through the opening 126 in the wall of the cabinet or control panel 112, and through the opening 120 of the bezel 116, such that a knob 118 having a corresponding mounting arrangement can be mounted on the stem 134. The control knob 118 can be arranged to be adjacent to the bezel 116. In another embodiment, as shown in FIG. 8, the bezel 116 can be designed such that the control knob 118 is nested or partially nested within the walls of the bezel 116. In this way, the walls of the bezel 116 extend up around a portion of the sides of the knob 118 and the bezel 116 rotates concentric to the knob 118.

With reference to the example illustrated in FIG. 9, another module 110 (such as gas burner or gas cooking device) may have a control design which includes a gas valve 138 mounted behind a wall of the cabinet or control panel 112. The gas valve 138 can include a stem 140 (e.g., a thin stem, thin metal stem, etc.), which extends forward from the gas valve 138 through the opening 126 in the wall of the cabinet or control panel 112, and through the opening 120 of the bezel 116, such that a knob 118 having a corresponding mounting arrangement can be mounted on the stem 140. In this way, the knob 118 provides a direct mechanical connection to the gas valve 138 that controls, for example, a gas burner or other component or module of the appliance, while also providing the bezel 116 for turning a module on and off.

As shown in FIG. 9, the bezel 116 can be designed such that the control knob 118 is nested or partially nested within the walls of the bezel 116. Similar to the exemplary embodiment of FIG. 5B, the bezel 116 illustrated in the embodiment of FIG. 9 includes an optional step or ledge 121 formed in the opening 120. The size and shape of the step 121 can be configured to receive a corresponding optional step portion 136 of the control knob 118. In this way, the walls of the bezel 116 extend up around a portion of the sides of the knob 118 and the bezel 116 rotates concentric to the knob 118. The exemplary features of a step or ledge 121 and step portion 136 are not particular or necessary for the arrangement shown in FIG. 9, and the universal bezel 116 shown in FIGS. 7 and 8 can be used with the gas valve 138 and corresponding knob 118 of FIG. 9.

In another example embodiment, the bezel 116 can accommodate a knob 118 that controls an encoder, which may be disposed behind the bezel 116 (e.g., inside the face plate of the appliance), to control the temperature of one of the cooking components or modules, such as the oven 102. In still another module, the input may include a shaft of a thermostat with a bulb.

The rotatable outer bezel 116 can be configured to control an ON/OFF actuation of a first cooking module 110 while the knob 118 controls a setting, such as a temperature setting, of the first cooking module 110. In this way, the present invention can provide for activation/deactivation of each module 110 in a simple, non-confusing manner with the least amount of hand movement as possible. For example, a user can turn the module 110 on using the rotatable outer bezel 116 while setting the temperature of the module 110 with a single hand motion using the knob 118. In an alternative embodiment, the rotatable outer bezel 116 can be configured to control an ON/OFF actuation of a first cooking module or a feature of the appliance or module, such as one or more lights of the appliance or module, while the knob 118 controls a function or setting of a second, different cooking module.

As explained above, the incorporation of various different cooking modalities into the household cooking appliance 100 (e.g., by incorporating one or more cooking modules 110 into the appliance 100) may increase power demand on the cooking appliance 100, depending on which modalities, or how many modalities, of the appliance 100 are being operated at the same time. As a result, a user may operate multiple modalities at the same time and exceed, for example, a desired or maximum amp limit for that particular appliance. For example, some household cooking appliances may have a maximum amperage limit such as 50 amps, 30 amps, etc., which may be exceed upon turning on one or more cooking modules 110 while other cooking modules are active or while other cooking components are active, such as oven 102, steam oven 104, warming drawer 106, etc. The bezel 116 of the present invention can be used to turn ON/OFF various modules 110 and/or components of the household cooking appliance 100 to maintain the total amperage drawn by the appliance under the maximum amperage limit. This may be particularly beneficial when the appliance includes a module 110, for example that is manufactured by another manufacturer such as an off-the-shelf pre-wired module, that is not configured to, or cannot, interface with a control board of the appliance.

To provide additional power management features, the present invention provides an exemplary embodiment, as shown in FIG. 10, in which the bezel 116 is configured to communicate with a controller 142 of the appliance 100. The ON/OFF functionality provided by the outer bezel 116 can be used to let the controller 142 know when a particular module 110 is active or inactive such that the controller 142 can enact appropriate power management strategies. If the overall amperage drawn by the appliance 100 when a component or module 110 is turned on by the bezel 116 exceeds a maximum allowable amps of the appliance 100, then the controller 142 can prevent the module 110 from being activated. For example, the appliance 100 can include an optional relay 144 that can be activated or deactivated by the controller 142 to supply power or interrupt the supply of power, respectively, to the module 110 based on the determination by the controller 142 with regard to whether the overall amperage drawn by the appliance 100 is or will be greater than the maximum allowable amps of the appliance 100. In alternative embodiments, a relay may not be provided and the controller may directly control the module. For example, the controller may include internal components or circuitry to control the supply of power to the module without providing a separate relay.

The appliance 100 also can include an optional notification device 146 in communication with the controller 142. The notification device 146 can provide one or more of an error signal, error message, or the like to notify the user of the appliance that use of the component or module will exceed the maximum allowable amps of the appliance and/or that one or more second components or modules must be turned off to reduce the total amps drawn by the appliance and free up allowable amperage for the first component or module to be operated. The notification device 146 can include various types of notifications, such as visual notifications or audible notifications or tactile notifications (e.g., vibration). For example, the notification device 146 can include one or more of a display device for displaying a text or image warning or notification, a light, a sound generating device, a vibrating device, among other common notifications means. In an embodiment, the control panel 112 can provide an interface for a user regarding which components or modules are turned ON/OFF such that the user can easily and effortlessly maintain the total amperage drawn by the appliance at or below the maximum amps for the particular model or type of appliance.

With reference again to the example in FIG. 10, in operation, a user turns on a component or module 110 controlled by the bezel 116. The ON/OFF functionality provided by the outer bezel 116 lets the controller 142 know when a particular module 110 is active or inactive such that the controller 142 can enact appropriate power management strategies. The controller 142 determines if the amount of amps drawn by the component or module 110 will cause the total amps drawn by the appliance 100 to exceed the maximum allowable amperage of the appliance. If the maximum allowable amperage of the appliance 100 will not be exceeded, then the controller 142 turns on a relay 144 to supply power to the component or module 110. If the maximum allowable amperage of the appliance 100 will be exceeded, then the controller 142 does not turn on the relay 144 and instead provides one or more of an error signal, error notification, error message, or the like using notification device 146 to inform the user that use of the component or module 110 will exceed the maximum allowable amps of the appliance and/or that one or more additional components or modules must be turned off to reduce the total amps drawn by the appliance 100 to free up allowable amperage for this component or module 110 to be operated. As shown in FIG. 10, a knob 118 can control a setting, such as a temperature setting, of the component or module 110.

With reference to FIG. 11, another embodiment of the present invention provides a plurality of bezels 116a-116c for activating or deactivating a plurality of corresponding modules 110a-110c. Each of the bezels 116a-116c are configured to communicate with a controller 142 of the appliance 100. The ON/OFF functionality provided by each outer bezel 116 can be used to let the controller 142 know which of the modules 110a-110c are active or inactive such that the controller 142 can enact appropriate power management strategies. If the overall amperage drawn by the appliance 100 when one of the modules 110a-110c is turned on exceeds a maximum allowable amps of the appliance 100, then the controller 142 can prevent, or selectively prevent, the respective module from being activated and/or reduce the power draw elsewhere in the appliance (e.g., dim oven lights, slow a preheat cycle, etc.) to permit one or more of the modules to be activated without exceeding the maximum allowable amps of the appliance. For example, the appliance 100 can include a plurality of corresponding optional relays 144a-144c that can be activated or deactivated by the controller 142 to supply power or interrupt the supply of power, respectively, to each respective module 110a-110c based on the determination by the controller 142 with regard to whether the overall amperage drawn by the appliance 100 is or will be greater than the maximum allowable amps of the appliance 100. In an embodiment, one or more of the modules 110a-110c can include a knob 118 (not shown in FIG. 11; see similar arrangement, for example, in FIG. 10) that controls, for example, a setting, such as a temperature setting, of the component or module 110a-110c.

For example, with reference again to the example in FIG. 11, in operation, a user turns on a first module 110a controlled by the bezel 116a. The controller 142 determines if the amount of amps drawn by the first module 110a will cause the total amps drawn by the appliance 100 to exceed the maximum allowable amperage of the appliance 100. If the maximum allowable amperage of the appliance 100 will not be exceeded, then the controller 142 turns on relay 144a to supply power to the first module 110a. If the maximum allowable amperage of the appliance 100 will be exceeded by operating the module 110a, then the controller 142 does not turn on the relay 144a and instead provides one or more of an error signal, error notification, error message, or the like using notification device 146 to inform the user that use of the first module 110a will exceed the maximum allowable amps of the appliance and/or that one or more additional modules (e.g., 102, 104, 106, 108, 110b, 110c) must be turned off to reduce the total amps drawn by the appliance 100 to free up allowable amperage for the first module 110a to be operated. Alternatively, the controller 142 may dim oven lights, slow a preheat cycle, etc., to free up power before permitting module 110a to operate.

In another exemplary embodiment, the ON/OFF functionality provided by the outer bezel 116 can be used as an additional safety layer to prevent unintentional activation of a module 110. For example, if a particular module 110 requires the outer bezel 116 to be turned to the ‘ON’ position to operate, an unintentional or accidental bumping or turning of the control knob 118 for the module 110 by a user will not activate the module 110, thereby providing an additional safety layer on top of existing safety features of control knobs 118. In another example, the ON/OFF functionality provided by the outer bezel 116 can be configured to provide a child safety layer, or an additional child safety layer, to deter or prevent activation of the module 110 by a child.

The present invention has been described herein in terms of several preferred embodiments. However, modifications and additions to these embodiments will become apparent to those of ordinary skill in the art upon a reading of the foregoing description. It is intended that all such modifications and additions comprise a part of the present invention to the extent that they fall within the scope of the several claims appended hereto.

What is claimed is:

1. A dual-encoder ON/OFF selector for a cooking module of a household appliance, the dual-encoder ON/OFF selector comprising:
a rotatable bezel controlling at least one of activation and deactivation of the cooking module, the rotatable bezel being rotatable between an ON position and an OFF position for the cooking module,
wherein the rotatable bezel includes an opening configured to receive a rotatable control knob extending through the opening in either direction such that the rotatable control knob is concentrically arranged with the rotatable bezel.

2. The dual-encoder ON/OFF selector of claim 1, further comprising the rotatable control knob, wherein the rotatable control knob is disposed one of adjacent to the rotatable bezel and in at least a partially nested position within the opening of the rotatable bezel.

3. The dual-encoder ON/OFF selector of claim 1, wherein the opening of the rotatable bezel includes a step portion for receiving a corresponding step portion of the control knob.

4. The dual-encoder ON/OFF selector of claim 1, further comprising a base support for mounting on a control panel of the household cooking appliance between the rotatable bezel and the control panel,
wherein the rotatable bezel is movable with respect to the base support between the ON position and the OFF position for the cooking module.

5. The dual-encoder ON/OFF selector of claim 1, further comprising an ON/OFF switch, wherein rotation of the rotatable bezel between the ON position and the OFF position at least one of actuates and deactivates the ON/OFF switch.

6. The dual-encoder ON/OFF selector of claim 5, wherein the ON/OFF switch is integrally formed with the rotatable bezel.

7. The dual-encoder ON/OFF selector of claim 5, wherein the ON/OFF switch is configured to be mounted on a control panel of the household cooking appliance.

8. The dual-encoder ON/OFF selector of claim 1, further comprising an ON/OFF switch, wherein the rotatable bezel includes a fixed ring and a rotatable ring that is movable with respect to the fixed ring, and
wherein rotation of the rotatable ring at least one of actuates and deactivates the ON/OFF switch.

9. The dual-encoder ON/OFF selector of claim 1, further comprising the rotatable control knob, wherein the rotatable control knob is selected from one of a plurality of different control knobs having a universal outward appearance and different arrangements for interfacing with a plurality of different types of control devices.

10. The dual-encoder ON/OFF selector of claim 9, wherein the rotatable control knob is configured to receive a stem of a control device that is mounted on an opposite side of a control panel of the household appliance from the rotatable bezel, the stem passing through the opening of the rotatable bezel from a rearward direction.

11. The dual-encoder ON/OFF selector of claim 9, wherein the rotatable control knob includes a stem of a control device, the stem passing through the opening of the rotatable bezel from a forward direction.

12. The dual-encoder ON/OFF selector of claim 11, wherein the control device is integrally formed in the rotatable control knob.

13. The dual-encoder ON/OFF selector of claim 1, wherein the rotatable bezel is configured to communicate with a controller of the household cooking appliance, the controller controlling operation of the cooking module.

14. The dual-encoder ON/OFF selector of claim 1, wherein the cooking module includes at least one of a steam oven, a warming drawer, a convection oven, a gas burner, a griddle, a grill, a teppanyaki grill, an induction heating element, a surface steamer bay, a wok burner, and a deep fryer.

15. A household cooking appliance comprising:
a cooking module;
a control panel;
a rotatable control knob on the control panel; and
a dual-encoder ON/OFF selector for the cooking module on the control panel, the dual-encoder ON/OFF selector including a rotatable bezel controlling at least one of activation and deactivation of the cooking module, the rotatable bezel being rotatable between an ON position and an OFF position for the cooking module,
wherein the rotatable bezel includes an opening, and
wherein the rotatable control knob extends through the opening of the rotatable bezel and is concentrically arranged with the opening of the rotatable bezel.

16. The household cooking appliance of claim 15, wherein the rotatable control knob is disposed one of adjacent to the rotatable bezel and in at least a partially nested position within the opening of the rotatable bezel.

17. The household cooking appliance of claim 15, wherein the rotatable control knob includes a stepped sidewall portion facing the rotatable bezel, and
wherein the opening of the rotatable bezel includes a step portion for receiving the stepped sidewall portion of the control knob.

18. The household cooking appliance of claim 15, wherein the dual-encoder ON/OFF selector for the cooking module includes a base support mounted on the control panel between the rotatable bezel and the control panel, and
wherein the rotatable bezel is movable with respect to the base support between the ON position and the OFF position for the cooking module.

19. The household cooking appliance of claim 15, further comprising an ON/OFF switch, wherein rotation of the rotatable bezel between the ON position and the OFF position at least one of actuates and deactivates the ON/OFF switch.

20. The household cooking appliance of claim 19, wherein the ON/OFF switch is integrally formed with the rotatable bezel.

21. The household cooking appliance of claim 19, wherein the ON/OFF switch is mounted on the control panel.

22. The household cooking appliance of claim 15, further comprising an ON/OFF switch, wherein the rotatable bezel includes a fixed ring and a rotatable ring that is movable with respect to the fixed ring, and
wherein rotation of the rotatable ring at least one of actuates and deactivates the ON/OFF switch.

23. The household cooking appliance of claim 15, wherein the rotatable control knob is selected from one of a plurality of different control knobs having a universal outward appearance and different arrangements for interfacing with a plurality of different types of control devices.

24. The household cooking appliance of claim 23, further comprising:
a control device mounted on an opposite side of the control panel from the rotatable bezel,
wherein the control device includes a stem passing through an opening in the control panel and through the opening of the rotatable bezel from a rearward direction, and
wherein the rotatable control knob receives the stem of the control device such that the rotatable control knob is operable to actuate the control device.

25. The household cooking appliance of claim 23, further comprising:
a control device mounted on an opposite side of the control panel from the rotatable bezel,
wherein the rotatable control knob includes a stem that engages the control device, the stem passing through the opening of the rotatable bezel and through an opening in the control panel from a forward direction, and
wherein the control device receives the stem of the rotatable control knob such that the rotatable control knob is operable to actuate the control device.

26. The household cooking appliance of claim 23, wherein a control device is integrally formed in the rotatable control knob.

27. The household cooking appliance of claim 14, further comprising a controller that controls operation of the cooking module,
wherein the rotatable bezel communicates with the controller.

28. The household cooking appliance of claim 27, wherein, if the controller determines that an amount of amperage drawn by the household cooking appliance when the cooking module is turned ON by the rotatable bezel will be greater than a predetermined allowable amperage for the household cooking appliance, then the controller at least one of prevents the cooking module from being activated by the rotatable bezel and adjusts a power draw of another component of the household cooking appliance to compensate for activating the cooking module such that the amount of amperage drawn by the household cooking appliance when the cooking module is turned ON by the rotatable bezel will be equal to or less than the predetermined allowable amperage for the household cooking appliance, and
wherein, if the controller determines that the amount of amperage drawn by the household cooking appliance when the cooking module is turned ON by the rotatable bezel will be equal to or less than the predetermined allowable amperage for the household cooking appliance, then the controller permits the cooking module to be activated by the rotatable bezel.

29. The household cooking appliance of claim 28, further comprising a relay coupled between the controller and the cooking module,
wherein the controller deactivates the relay when the amount of amperage drawn by the household cooking appliance when the cooking module is turned ON by the rotatable bezel will be greater than the predetermined allowable amperage for the household cooking appliance, and activates the relay when the amount of amperage drawn by the household cooking appliance when the cooking module is turned ON by the rotatable bezel will be equal to or less than the predetermined allowable amperage for the household cooking appliance.

30. The household cooking appliance of claim 28, further comprising a notification device notify a user of the household cooking appliance that use of the cooking module will exceed the predetermined allowable amperage for the household cooking appliance.

31. The household cooking appliance of claim 30, further comprising:
one or more additional cooking modules,
wherein the notification device includes a user interface that notifies the user which of the additional cooking modules are turned ON such that the user can deactivate one or more of the additional cooking modules to permit activation of the cooking module without exceeding the predetermined allowable amperage for the household cooking appliance.

32. The household cooking appliance of claim 15, wherein the cooking module includes at least one of a steam oven, a warming drawer, a convection oven, a gas burner, a griddle, a grill, a teppanyaki grill, an induction heating element, a surface steamer bay, a wok burner, and a deep fryer.
